(19) United States
(12) Patent Application Publication
(10) Pub. No.: US 2002/0002552 A1
(43) Pub. Date: Jan. 3, 2002

(54) Method and apparatus for a GIS based search engine utilizing real time advertising

(76) Inventors: Troy L. Schultz, Slow, OH (US); Anthony A. Romito, Uniontown, OH (US); Brett A. Urian, Wooster, OH (US)

Correspondence Address: Daniel A. Thomson, One Cascade Plaza, Fourteenth Floor, Akron, OH, 44308-1147, US

(21) Appl. No.: 09/896,602

(22) Filed: Jun. 29, 2001

Related U.S. Application Data
(60) Provisional application No. 60/215,635, filed on Jun. 30, 2000.
(60) Provisional application No. 60/224,430, filed on Aug. 11, 2000.

(51) Int. Cl. G06F 17/60; G06F 7/00; G06F 17/30; G06F 17/00

(52) U.S. Cl. 707/3; 705/1; 705/14; 707/104.1

(57) ABSTRACT

The present invention provides for a global computer network geographic information system, or GIS, based search engine. The GIS search engine utilizes a geographic information system, or GIS, to extend the functionality of traditional databases by combining spatial features with information records. The GIS search engine correlates a business and its relevant information, such as its products and services, to a record in the database of the GIS system that corresponds to a unique geographical location. This correlation enables the GIS based search engine to limit its search results to user defined geographic criteria. In addition, the GIS based search engine can be combined with real time advertising to create a dynamic “yellow page reference.” Thus, the search engine will not only provide the name, phone number, and/or address of the business, but it can also provide additional information on the business. In other words, the search engine will provide advertising for the business. The advertising can vary from a simple text line to a full web page ad, depending on needs of the business. Further, the business can update the advertisements as often as it likes by uploading real time information to the databases used by the search engine.

This application claims the benefit of U.S. Provisional Application, Serial No. 60/215,635, filed on Jun. 30, 2000, entitled GEO-CODED SEARCH ENGINE and U.S. Provisional Application, Serial No. 60/224,430, filed on Aug. 11, 2000, entitled IGIS BASED INTERNET SEARCH ENGINE, DYNAMIC ADVERTISING AND COMMERCE PLATFORM.

### BACKGROUND OF THE INVENTION

A. Field of Invention

This invention pertains to the field of search engines and more specifically to a GIS (geographic information system) based search engine utilizing real time advertising.

B. Description of the Related Art

With the increasing popularity of the Internet and the World Wide Web, it is common for both businesses and individuals (i.e. users) to utilize on-line search engines, such as Yahoo®, Excite®, Dogpile®, Google™, and Infoseek®, to search for business related information. For example, users often use these search engines to look for a business that provides a particular product or service that is close to their location. Thus, the user will use the search engine to search for the particular product or service in the hopes of finding a desired business close to their location. Unfortunately, the search engines generally provide national or, even, global search results. Thus, the search engines often find businesses that are located in areas far outside of what may be practical to the user.

Further, these search engines can only search for businesses that have active web pages, news, or advertising on the Internet. As such, the user must often turn to a typical reference manual, such as business-to-business yellow pages or regional yellow pages to find the business information they are searching for. However, these traditional references neither provide information on how far a business is from the user's location nor do they provide information on whether or not there is another business that is closer to the user's location. In addition, these references lack the dynamic or real time advertising capabilities of the Internet.

There are several search engines available that allow users to search by a predefined or “canned” geographic region, such as a city or a county. Unfortunately, the search results for these search engines are not very specific. For example, the search engines would not provide information on a business that is closer to the user, but outside the “canned” geographic region. Further, many users may know the geographic area they want to search but not the best name of the “canned” geographic region or the best key words to search by. And, some users, such as those users who have recently moved into an area or travelers, may not know which “canned” geographic region to search in. Thus, what is needed is a search engine that can search by a specific, user-defined geographic area, such as a property address, latitude and longitude, or any unified geocoding system.

The present invention provides for an Internet geographic information system based search engine. The GIS search engine utilizes a geographic information system, or GIS, to extend the functionality of traditional databases by combining spatial features with information records. The search engine correlates a business and its relevant information, such as its products and services, to a record in the database of the GIS system that corresponds to a unique geographical location. This correlation enables the GIS-based search engine to limit its search results to specific, user-defined geographic criteria.

In addition, the GIS-based search engine can be combined with real time advertising to create a dynamic “yellow page reference.” Thus, the search engine will not only provide the name, phone number, and/or address of the business, but it can also provide additional information on the business. In other words, the search engine will provide advertising for the business. The advertising can vary from a simple text line to a full web page ad, depending on needs of the business. Further, the business can update the advertisements as often as it likes by uploading real time information to the databases used by the search engine.

### DEFINITIONS

Computer network—This term is intended to have as broad a definition as possible. The definition is intended to encompass all networks, including global computer networks, local area networks, wide area networks, and virtual private networks.

Entity—any 1) business; 2) government, non-government, or quasi-government agency; and/or 3) non-profit or for-profit organization.

Geometric Corridor—any irregular or regular shaped polygon.

Information—This term is intended to have as broad a definition as possible. The information may include any data collected or included in, or data related to the data collected or included in, a particular database.

Search Engine—computer software used to search data (as text, graphic, sound, coordinate, or a database) for specified information.

Search Result—any result returned in response to a query, including no matching information.

### SUMMARY OF THE INVENTION

In accordance with the present invention, a method for utilizing a GIS-based search engine to limit search results to a user-defined geographic area includes the steps of providing a search engine having a geographic information system database and an information database, the geographic information system database including data on a specified geographic area, receiving an information query from a user, searching for the information query in the information database to produce information search results, identifying any information search results corresponding to the specified geographic area, and providing the identified search results to the user.

In accordance with another aspect of the present invention, the method further includes the step of utilizing a sorting criteria to sort the search results.

In accordance with another aspect of the present invention, the method includes the step providing advertising for the identified search result.

In accordance with another aspect of the present invention, the method further includes the step of updating the advertisements to provide dynamic advertising.

In accordance with another aspect of the present invention, a method for associating a unified geocoding system coordinate with a search criteria includes the steps of providing a search engine associated with a geographic information system database and an information database, receiving a query from an associated user, searching for at least one search result, identifying the at least one search result corresponding to a specified geographic area, and providing the at least one identified search result to the associated user.

In accordance with yet another aspect of the present invention, the method also includes the steps of identifying multiple search results corresponding to a specified geographic area, utilizing at least one sorting criterion, and sorting the search results, wherein the at least one sorting criterion is selected from the group comprising: distance from a selected geographic location, time, price, and alphabetical order, wherein the query is at least one entity criterion, wherein the entity criterion is chosen from the group comprising product name, brand name, product category, service name, service category, business name, event, event forum, price, time, and combinations thereof.

In accordance with still another aspect of the present invention, the method includes the steps of updating the information database, wherein the specified geographic location is chosen from the group comprising distance from a zip code, distance from an area code, distance from a telephone exchange area, distance from a state, distance from longitudinal and latitudinal coordinates, distance from state planar coordinates, a geometric corridor, distance from a unified geocoding system coordinate, and combinations thereof, providing advertising data for the entity, and providing the data to the associated user.

In accordance with another aspect of the present invention, the advertising data is chosen from the group comprising text, a graphic image, sound, a banner, a web page, and combinations thereof.

In accordance with another aspect of the present invention, the method includes receiving information for the information database from either a third party or from the entity, providing registering means for registering a geocoded user preference profile, providing notification to the associated user when an event matches the preference profile, updating event schedules, targeting event notifications to at least one specified geographic area, assigning relevance to each of the search results, and arranging the results in order of relevance.

In accordance with yet another aspect of the present invention, a computer readable medium containing instructions for controlling a computer system to perform a method includes the steps of providing a search engine associated with a geographic information system database and an information database, receiving a query from an associated user, searching for at least one search result, identifying the at least one search result corresponding to a specified geographic area, and providing the at least one identified search result to the associated user.

In accordance with another aspect of the present invention, the computer readable medium includes the steps of identifying multiple search results corresponding to a specified geographic area, utilizing at least one sorting criterion, and sorting the search results.

In accordance with another aspect of the present invention, the sorting criterion is selected from the group comprising distance from a selected geographic location, time, price, and alphabetical order.

In accordance with another aspect of the present invention, the computer readable medium includes the steps of assigning relevance to each of the search results, and arranging the results in order of relevance, wherein the query is at least one entity criterion, wherein the entity criterion is chosen from the group comprising product name, brand name, product category, service name, service category, business name, event, event forum, price, time, and combinations thereof.

In accordance with still another aspect of the present invention, the computer readable medium includes the steps of updating the information database, providing advertising data for the entity, providing the data to the associated user, providing registering means for registering a geocoded user preference profile, providing notification to the associated user when an event matches the preference profile, and targeting event notifications to at least one specified geographic area.

In accordance with yet another aspect of the present invention, a search engine includes a geographic information system database, an information database, means for searching the databases, and means for obtaining a search result corresponding to a specified geographic location.

In accordance with still another aspect of the present invention, the means for obtaining a search result corresponding to a specified geographic location includes means for identifying multiple search results corresponding to a specified geographic area, means for utilizing at least one sorting criterion, and means for sorting the search results.

In accordance with another aspect of the present invention, the sorting criterion is selected from the group comprising: distance from a selected geographic location, time, price, and alphabetical order.

In accordance with yet another aspect of the present invention, the search engine includes means for assigning relevance to each of the search results, means for arranging the results in order of relevance, means for updating the information database, means for providing advertising data for the entity, means for providing the data to the associated user, registering means for registering a geocoded user preference profile, means for providing notification to the associated user when an event matches the preference profile, and means for targeting event notifications to at least one specified geographic area.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, at least one embodiment of which will be described in detail in this specification and illustrated in the accompanying drawings which form a part hereof and herein:

FIG. 1 illustrates the GIS based search engine; and,

FIG. 2 illustrates a sample business index.

### DESCRIPTION OF SEVERAL EMBODIMENTS

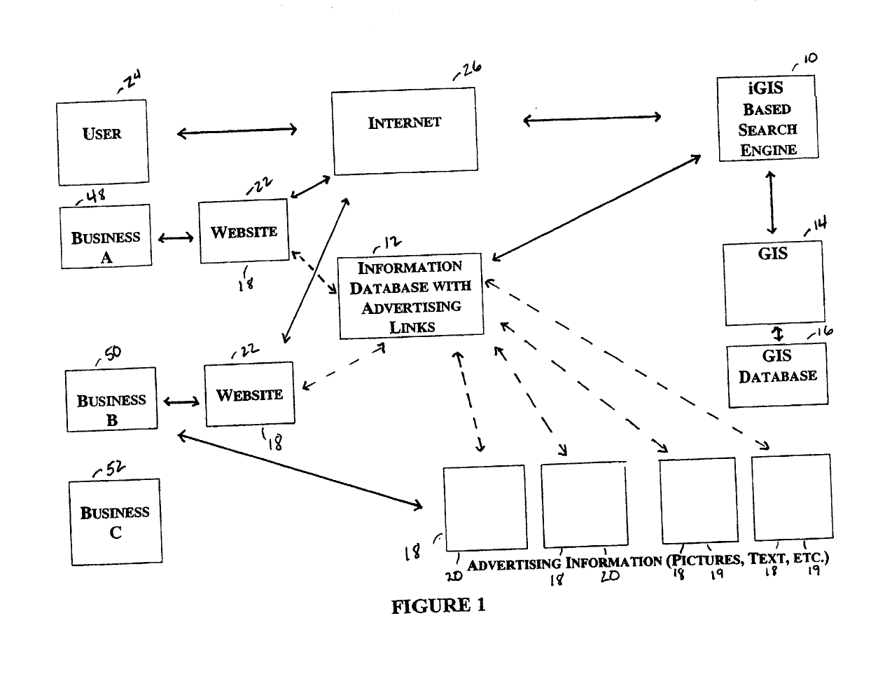

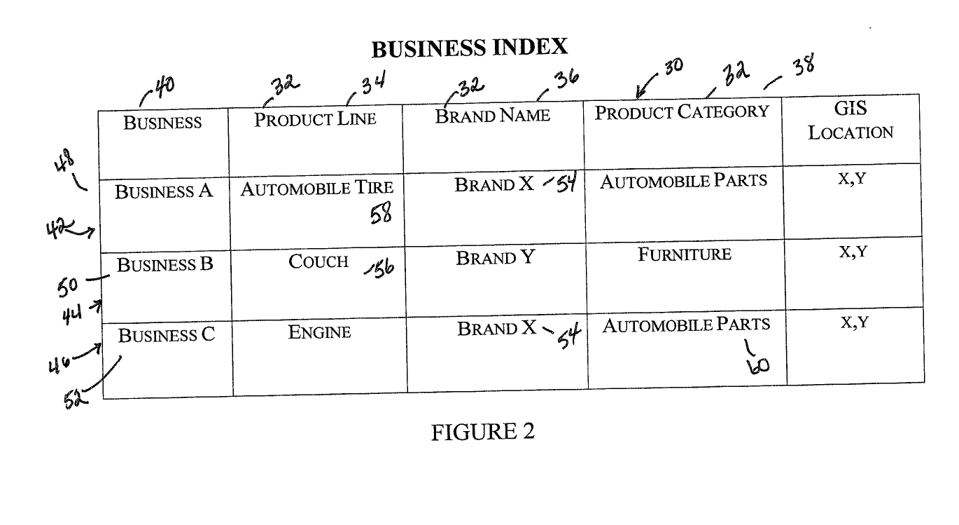

Referring now to the drawings wherein the showings are for purposes of illustrating at least one embodiment of the invention only and not for purposes of limiting the same, FIGS. 1 and 2 show the Internet GIS based search engine.

With reference to FIG. 1, the GIS based search engine and the components needed to implement the search engine are illustrated. The search engine includes an information database and a GIS having a GIS database that stores unique geographical locations, which are correlated by the search engine to records in an information database. The information database can optionally be associated with online advertising content, advertising databases, or links to other web sites. It is to be understood that the information database and the GIS database can either be interdependent or independent of each other. Any combination of databases and database types can be used, as long as chosen using sound engineering judgment.

In use, a user submits a search request via a computer network to the search engine, via a kiosk, voice recognition telephony, touch screen, wireless device, or any other technology which will act as an interface between a user and a computer network. The use of the computer network to submit such requests is well known in the art and, thus, will not be discussed in detail herein. The search request will include location data, an information query, and geographic criteria. The location data typically provides information on the user's geographic location. However, it can be any geographic reference location chosen by the user. Preferably, the location data is based on a unified geocoding system, but the location data can be any type of geographic location, such as a street, area code, zip code, city, county, state, longitudinal and latitudinal coordinates, geometric corridor, state planar coordinates, or any unified geocoding system.

In this embodiment of the invention, the information query is an entity criterion, such as a business name, a specific GIS location, a product name, a brand name, a service name, a price criterion, a time criterion, an event criterion, a service category, or combinations thereof. However, the information query can be any query that is correlated to the information stored on the information database.

The geographic criteria define the involvement of the GIS database in filtering the search results for the information query. The search can be limited to those results (i.e. businesses) that are located in a defined geographic area. For example, the geographic area may be a city, county, state, country, radial distance, or geometric corridor. The geographic criteria may also include the geographic area within a specified zip code, an area code, or the area defined by a specified radius from the location data, such as a street address, zip code, area code, state, longitudinal and latitudinal coordinates, any unified geocoding system, state planar coordinates, or combinations thereof. In addition, the search results can be limited to those results that are in closest proximity to the location data. For example, if the user enters his home street address as the location data, then he can request that the ten search results that are in closest proximity to his home be provided.

Once the GIS based search engine receives the information query, it searches the information database for information results which correspond to the information query. In this embodiment, the information query consists of entity criteria. Thus, the information database includes a business index comprised of fields that correlate to the criteria of the search query. In other words, the business index includes business fields which correspond to the entity criteria, such as a business name, GIS location, a product name, a brand name, a service name, or a service category. Each business record is associated uniquely with a particular entity.

An example of a business index is illustrated in FIG. 2. In this embodiment, the business index includes three records. Each record includes four business fields and an associated business, namely, Business A, Business B, and Business C. The business fields include a product name field, a brand name field, a product category field, and a GIS location. A user can search for any entity criteria that is correlated to the business index. For example, the user could search for Brand X. Since both Business A and Business B have Brand X in its product name field, both of these businesses would be identified in the search. However, if the user searched for a couch, only Business B would be identified. Or, if the user searched for automobile tires and automobile parts in the product category field, only Business A would be identified. This business index is only one type of information storage and does not limit the scope of this invention in any manner. Any type of information storage, which is chosen within sound business judgment, may be used.

Since various methods of using a search engine to search a database for a user-defined query are well known in the art, these methods will not be discussed herein in detail. It is sufficient to state that any method chosen within sound engineering and business judgment may be used.

The information for the business index will preferably be obtained from a third party, such as advertising companies, government agencies, business credit bureaus, yellow page providers, telecommunications company, etc. The telecommunications company will pay a fee, or other such compensation, to have information on its clients and their goods and/or services listed on the database. However, the information can also be obtained from other sources, such as individual entities.

In this embodiment, the information can be directly added, and/or updated by the individual entity. For example, if a restaurant wanted to update its information, the restaurant could simply access the database, the change the menu, phone number, address, etc. The geographic information can also be added by the restaurant by simply adding X, Y, and/or Z coordinates for the restaurant. The inventive system also allows individual entities to enter their geographical information by reference to another known location. For example, if the business next to the restaurant has its geographic location information entered in the database, the restaurant owner can then inform the system, through a graphical computer interface, or other appropriate means, that his restaurant is right next door.

Once the GIS based search engine receives the geographic criteria, it utilizes the GIS database to identify any information search results, such as a business, which correspond to the geographic search criteria. Various methods are known in the art for relating the records in the information database to records in the GIS database. For example, the business index could include a geographic field that corresponds to the coordinates or other geographic identifiers used by the GIS databases. In other words, each business listed on the business index could be geocoded in reference to the GIS database. Alternatively, a unique identifier unrelated to the entity criteria or the geographic criteria can be used. However, the foregoing are only examples of relating the records and are not intended to limit the scope of this invention in any manner. As such, any method chosen within sound engineering and business judgment can be used.

The GIS search engine will sort the identified results according to a sorting criteria, preferably chosen by the user. The sorting criteria can be comprised of an alphabetical criteria, such as by the name of the business, a distance criteria, such as the distance from the user's location to the business, a size criteria, such as the size of the business, price criteria, time criteria, event criteria, or any other criteria chosen within sound business judgment.

Methods for sorting search results are well known in the art and will not be discussed in further detail herein. However, any method chosen within sound engineering or business judgment may be used.

In this embodiment, the information database is associated with additional advertising information. The advertising information may include, without limitation, information stored on an advertising database, links to associated web sites, such as those owned by the entities, information stored within the information database, and information stored on the GIS provider server. Thus, businesses will have the option of having not only their name submitted to a user, but also additional advertising information submitted to the user. For example, the advertising information could include text, such as a written description of the company, its products and/or services, a banner ad, and any specials or coupons offered by the business, graphic images, or sounds, such as aural advertisements or music.

The advertising information could also include a link to a web page for the business that is supported by the provider of the GIS based search engine or the business index database. This may be an attractive option to smaller businesses that cannot afford to develop and maintain their own web site. Or, links to the businesses' own independent web site could be provided to the user.

Further, in one embodiment of this invention, the advertising information can be updateable upon demand. Preferably, the database will be updateable in real-time, enabling the businesses to update the advertising information on a monthly, weekly, daily, or even an instantaneous basis. Thus, the businesses can continually upload information to the advertising database to provide users with information on new products and/or services, specials, and the like. This will allow the business to provide the user with dynamic and accurate information. Numerous means for uploading information to a database are well known in the art and will not be discussed further herein. However, any means chosen within sound engineering or business judgment may be used.

In another embodiment of this invention, promoters or producers of special events (concerts, air shows, exhibitions, community events, etc.) can advertise the event utilizing the GIS based search engine. Since the event information will be supported in a GIS data structure, users or interested parties will be able to obtain event information through use of the GIS based search engine accessed through the computer network.

Users may search for specific events, or events within general search categories, that will be held within a geographic area of interest and within a specified time frame of interest. Users will also be provided with the capability to register a geocoded user preference profile with the GIS search engine, information database, and/or advertising database that will be used to provide automatic e-mail notification (or notification through any electronic notification system distributed through a computer network) when an advertised event matches the specifications contained in the geocoded user preference profile.

Advertisers will also be provided the with the ability to update event schedules or other specific features in real time prior to, during, or after an event. Advertisers will also have the ability to target their event notifications to specific geometric or geographic areas.

In this embodiment, when a positive result is returned, the results can be arranged according to relevance. The results could be arranged by proximity to a particular location, price, time, event preference, product or service preference, or any other relevancy criteria chosen using sound business judgment.

The invention has been described with reference to several embodiments. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A method for associating a unified geocoding system coordinate with a search criteria, the method comprising the steps of:
providing a search engine associated with a geographic information system database and an information database;
receiving a query from an associated user;
searching for at least one search result;
identifying the at least one search result corresponding to a specified geographic area; and,
providing the at least one identified search result to the associated user.

2. The method of claim 1, wherein identifying the at least one search result corresponding to a specified geographic area comprises the steps of:
identifying multiple search results corresponding to a specified geographic area;
utilizing at least one sorting criterion; and,
sorting the search results.

3. The method of claim 2, wherein the at least one sorting criterion is selected from the group comprising: distance from a selected geographic location, time, price, and alphabetical order.

4. The method of claim 3, wherein the query is at least one entity criterion.

5. The method of claim 4, wherein the entity criterion is chosen from the group comprising product name, brand name, product category, service name, service category, business name, event, event forum, price, time, and combinations thereof.

6. The method of claim 1, wherein the method further comprises the step of:
updating the information database.

7. The method of claim 1, wherein the method further comprises the step of:
updating the GIS database.

8. The method of claim 5, wherein the specified geographic location is chosen from the group comprising:
(a) distance from a zip code;
(b) distance from a telephone exchange area;
(c) distance from an area code;
(d) distance from a state;
(e) distance from longitudinal and latitudinal coordinates;
(f) distance from state planar coordinates;
(g) a geometric corridor;
(h) distance from a unified geocoding system coordinate; and,
(i) combinations of a, b, c, d, e, f, g, and h.

9. The method of claim 8, wherein the method further comprises the steps of:
providing advertising data for the entity; and,
providing the data to the associated user.

10. The method of claim 9, wherein the advertising data is chosen from the group comprising:
(a) text;
(b) a graphic image;
(c) sound;
(d) a banner;
(e) a web page; and,
(f) combinations of a, b, c, d, and e.

11. The method of claim 10, wherein the method further includes the step of:
receiving information for the information database from at least one third party.

12. The method of claim 10, wherein the method further comprises the step of:
receiving information for the information database from the entity.

13. The method of claim 3, wherein the method further comprises the steps of:
providing registering means for registering a geocoded user preference profile; and,
providing notification to the associated user when an event matches the preference profile.

14. The method of claim 13, wherein the method further comprises the step of:
updating event schedules.

15. The method of claim 14, wherein the method further comprises the step of:
targeting event notifications to at least one specified geographic area.

16. The method of claim 3, wherein the method further comprises the steps of:
assigning relevance to each of the search results; and,
arranging the results in order of relevance.

17. A computer readable medium containing instructions for controlling a computer system to perform a method, the method comprising the steps of:
providing a search engine associated with a geographic information system database and an information database;
receiving a query from an associated user;
searching for at least one search result;
identifying the at least one search result corresponding to a specified geographic area; and,
providing the at least one identified search result to the associated user.

18. The computer readable medium of claim 17, wherein identifying the at least one search result corresponding to a specified geographic area comprises the steps of:
identifying multiple search results corresponding to a specified geographic area;
utilizing at least one sorting criterion; and,
sorting the search results.

19. The computer readable medium of claim 18, wherein the at least one sorting criterion is selected from the group comprising: distance from a selected geographic location, time, price, and alphabetical order.

20. The computer readable medium of claim 19, wherein the method further comprises the steps of:
assigning relevance to each of the search results; and,
arranging the results in order of relevance.

21. The computer readable medium of claim 19, wherein the query is at least one entity criterion, wherein the entity criterion is chosen from the group comprising product name, brand name, product category, service name, service category, business name, event, event forum, price, time, and combinations thereof.

22. The computer readable medium of claim 17, wherein the method further comprises the step of:
updating the information database.

23. The computer readable medium of claim 17, wherein the method further comprises the step of:
updating the GIS database.

24. The computer readable medium of claim 22, wherein the method further comprises the steps of:
providing advertising data for the entity; and,
providing the data to the associated user.

25. The computer readable medium of claim 19, wherein the method further comprises the steps of:
providing registering means for registering a geocoded user preference profile; and,
providing notification to the associated user when an event matches the preference profile.

26. The computer readable medium of claim 25, wherein the method further comprises the step of:
targeting event notifications to at least one specified geographic area.

27. A search engine comprising:
a geographic information system database;
an information database;
means for searching the databases; and,
means for obtaining a search result corresponding to a specified geographic location.

28. The search engine of claim 27, wherein means for obtaining a search result corresponding to a specified geographic location comprises:
means for identifying multiple search results corresponding to a specified geographic area;
means for utilizing at least one sorting criterion; and,
means for sorting the search results.

29. The search engine of claim 28, wherein the at least one sorting criterion is selected from the group comprising: distance from a selected geographic location, time, price, and alphabetical order.

30. The search engine of claim 29, wherein the search engine further comprises:
means for assigning relevance to each of the search results; and,
means for arranging the results in order of relevance.

31. The search engine of claim 29, wherein the search engine further comprises:
means for updating the information database.

32. The search engine of claim 29, wherein the search engine further comprises:
means for updating the GIS database.

33. The search engine of claim 31, wherein the search engine further comprises:
means for providing advertising data for the entity; and,
means for providing the data to the associated user.

34. The search engine of claim 33, wherein the search engine further comprises:
registering means for registering a geocoded user preference profile; and,
means for providing notification to the associated user when an event matches the preference profile.

35. The search engine of claim 34, wherein the search engine further comprises:
means for targeting event notifications to at least one specified geographic area.
